(19) United States
(12) Patent Application Publication
(10) Pub. No.: US 2006/0048142 A1
(43) Pub. Date: Mar. 2, 2006

(54) System and method for rapid response network policy implementation

(76) Inventors: John J. Roese, Newmarket, NH (US); Richard W. Graham, Derry, NH (US); David Harrington, Portsmouth, NH (US); James Richmond, Northfields, NH (US)

Correspondence Address: CHRIS A. CASEIRO, VERRILL DANA, LLP, ONE PORTLAND SQUARE, PORTLAND, ME, 04112-0586, US

(21) Appl. No.: 10/932,824

(22) Filed: Sep. 2, 2004

(51) Int. Cl. G06F 9/445

(52) U.S. Cl. 717/176; 717/171

(57) ABSTRACT

A system and method for rapidly responding to triggering events or activities in a network system. The system includes a policy enforcement function, a policy manager function, and one or more network devices of the network system. The policy enforcement function includes one or more installed policy sets and/or policy enforcement rule sets suitably responsive to triggering events or activities. Upon detection of a trigger, the policy manager function analyzes the trigger and selects one or more appropriate policy sets and/or policy enforcement rule sets deemed to be responsive to the trigger. Each set has a unique rapid response identifier. The policy manager function signals for implementation of the one or more policy and/or rule sets, based on one or more rapid response identifiers, which are enforced through the policy enforcement function. The policy enforcement function may be a part of one or more of the one or more network infrastructure devices for implementing the policy change. The system and method enable rapid response to a detected trigger (which might be a manual input) by pre-installing responsive policy and/or rule sets first and then generating and transmitting the unique rapid response identifier(s) corresponding to one or more selected policy and/or rule sets for implementation. That is, the network device is already configured with a response through the pre-installed policy and/or rule sets. Responses may be implemented and/or removed gradually, and different network devices may be instructed to implement different policies in response to the same trigger and the same policy may be implemented with different policy enforcement rules on different devices, ports, or interfaces.

### BACKGROUND OF THE INVENTION

1. Field of the Invention

The present invention relates to systems and methods for responding to conditions of network operation requiring a change of network services usage. More particularly, the present invention relates to systems and methods for configuring one or more network devices to implement such changes.

2. Description of the Prior Art

Interconnected computing systems having some sort of commonality form the basis of a network. A network permits communication or signal exchange among computing systems of a common group in some selectable way. The interconnection of those computing systems, as well as the devices that regulate and facilitate the exchange among the systems, represent a network. Further, networks may be interconnected together to establish internetworks. For purposes of the description of the present invention, the devices and functions that establish the interconnection represent the network infrastructure. The users, computing devices and the like that use that network infrastructure to communicate are referred to herein as attached functions and will be further defined. The combination of the attached functions and the network infrastructure will be referred to as a network system.

Presently, access to applications, files, databases, programs, and other capabilities associated with the entirety of a discrete network is restricted primarily based on the identity of the user and/or the network attached function. For the purpose of the description of the present invention, a “user” is a human being who interfaces via a computing device with the services associated with a network. For further purposes of clarity, a “network attached function” or an “attached function” may be a user connected to the network through a computing device and a network interface device, an attached device connected to the network, a function using the services of or providing services to the network, or an application associated with an attached device. Upon authentication or other form of confirmation of the offered attached function identity, the attached function may access network services at the level permitted for that identification. For purposes of the present description, “network services” include, but are not limited to, access, Quality of Service (QoS), bandwidth, priority, computer programs, applications, databases, files, and network and server control systems that attached functions may use or manipulate for the purpose of conducting the business of the enterprise employing the network as an enterprise asset.

A network administrator grants particular permissions to particular attached functions by establishing policies which are enforced at various points in the network. A policy is an action (or nonaction) to be undertaken based on the existence or occurrence of a defined condition or event referred to herein as a trigger. Policies are generally directed to administration, management, and/or control of access to or usage of network services. A policy may also be a policy abstraction that is the translation of one or more policies to a different level of abstraction. For example, multiple policies may be bundled into a higher-level abstract policy for ease of handling and naming; a policy set is simply a policy composed of one or more policies. A policy enforcement rule is a set of instructions or steps to be performed to implement the specified action defined by a policy. Particular policy enforcement rules are dependent upon the particular network infrastructure device and its programming. As a result, a given policy may be enforced differently by two different devices. In general, it can be stated that simple infrastructure devices may enforce a policy in a gross manner, while sophisticated infrastructure devices may enforce the same policy in a more tailored manner. For example, a policy may be that the detection of a virus must result in a blocking operation. On the simple device, that may be blocking a port completely, whereas on the sophisticated device, that may be blocking traffic involving a specific MAC address. Some policy enforcement rules are described in Internet Engineering Task Force (IETF) Request For Comments (RFC) 3198 and 3060.

A network session is the establishment of an association between an attached function and one or more network services through the network infrastructure. It is to be understood, however, that a network system may be embodied in the combination or interrelation between one or more attached functions and one or more network infrastructure devices. In general in the prior art, policies and policy enforcement rules are established prior to the creation of a network session but not specifically implemented in advance on a network device. At the outset of a network session, often in relation to the authentication of the entity requesting the session, an association is created between the session and one or more network services, constrained by one or more policies enforced based on policy enforcement rules carried out by one or more devices of the network infrastructure. Any later adjustment tends to occur manually in an effort to respond to an intrusion event or activity of some type.

Under RFC 3198, a network entity that “enforces” policies is called a Policy Enforcement Point (PEP). The PEP evaluates rule conditions and subsequently applies rule actions. For example, an email policy may contain rules to constrain the bandwidth (the amount of traffic forwarded within a given timeframe); the PEP enforces the rule by recognizing email traffic (i.e., evaluating the rule condition) and limiting the amount of traffic forwarded within the specified timeframe (i.e., executing the rule action).

Further under RFC 3198, policies are distributed to network entities by a Policy Decision Point (PDP), which utilizes administrator-defined rules to “decide” which policies should be distributed to which entities. The decision may be made to pre-configure policies in a PEP prior to processing events; this is called “provisioned policy.” The decision may be made dynamically in response to some network event, where the PEP detects the event and sends a “policy request” to the PDP to determine which policy should be applied; this is referred to as “outsourced policy.” Policies may be distributed to a PEP before the start of any network session, when a network session is started, or during a network session in response to various conditions, such as a change in business policy that leads to changes in network policies. Policies may be altered dynamically, prior to distribution, based on certain parameters, such as the IP address of an attached function or the authenticated identity of a user. It is to be understood that while reference is made herein to specific aspects of IETF RFC descriptions and definitions, the present invention encompasses such policy provisioning means as well as other means for regulating and protecting network functions. The terms PDP and PEP may be employed herein, however, generic reference to policy provisioning and enforcement may be made and deemed to include PDP and PEP functions.

Events and activities do occur that may be harmful to the network system. For purposes of this description, harm to the network system includes, for example, denying access to the network, denying access to the service once permitted access to the network, intentionally tying up network computing resources, intentionally forcing bandwidth availability reduction, and restricting, denying or modifying network-related information. There are currently two generally available forms of network protection designed to minimize such types of network harm: firewalls and an Intrusion Detection Systems (IDS). Firewalls monitor, analyze and enforce all in one, and are designed to prevent the passage of packets to the network based on certain limited specific conditions associated with the packets. Firewalls do not permit packet passage for the purpose of further analysis nor do they enable assigned policy modifications.

IDSs only monitor traffic. They do not analyze nor do they enforce. They are generally more effective at monitoring/detecting potentially harmful traffic than are firewalls. They are designed to observe the packets, the state of the packets, and patterns of usage of the packets entering or within the network infrastructure for harmful behavior. However, until recently with the availability of the Distributed Intrusion Response System by Enterasys Networks of Andover, Mass., common owner of the invention described herein, the available IDSs do not prevent packet entry to the network infrastructure. Further, for the most part, they only alert a network administrator to the existence of potentially harmful behavior but do not provide an automated response to the detected occurrence. There is some limited capability to respond automatically to a detected intrusion. However, that capability is static in nature in that the response capability is ordinarily restricted to limited devices of the network infrastructure and the response is pre-defined and generated by the network administrator for implementation on specified network infrastructure devices.

For the most part, existing IDSs, whether network-based (NIDS), host-based (HIDS) or a combination of the two (NIDS/HIDS), report possible intrusions to a centralized application for further analysis. That is, all detected potentially harmful occurrences are transferred to a central processing function for analysis and, if applicable, alarm reporting. The detection functionality may reside in one or more appliances associated with one or more network entry devices. Each appliance provides its own report to the central processing function with respect only to those packets passing through it. The central processing function then conducts the analysis and the alarm reporting. Network administrators often restrict the intrusion detection functionality to certain parts or entry ports of the network system rather than to the entirety of the system. That is, for example, all packets entering a network infrastructure from an attached function may be forced to enter through one or more select entry functions. Those select entry functions form part of the centralized choke point or bottleneck arrangement to the network. They are typically chosen for throughput capacity and to simplify manual policy changes that may be required based upon an alarm occurrence.

Upon receipt of an alarm, the network administrator can either do nothing, or implement a response function through adjustment of the operation of one or more network infrastructure devices. The implementation of a response function may take a relatively significant amount of time, with the response delay, or latency, potentially allowing greater harm to, or at least reduced effectiveness of, the network system prior to the implementation of a function to address the triggering activity or event. In a network system in which only a select few network infrastructure devices have intrusion response functionality, the implemented response may result in more widespread restriction of network usage than may be warranted by the triggering activity or event. The response may also be excessive if a greater number of network infrastructure devices are configured to respond to an attack than the scope of the intrusion warrants. It would be preferable to have a response capability that is implementable as quickly as possible in a manner that substantially ensures repulsion/neutralization of a triggering activity or event, such as an attack, while the system goes through the process of establishing a revised set of policies to specifically address the activity or event only, and in a targeted manner if that appears to be the appropriate response.

As indicated, other than the Enterasys Distributed Intrusion Response System, the presently available IDSs only report the existence of potentially harmful activities, events or occurrences, and do not enable responsive policy modification. Any adjustment to the state of permitted attached function network usage typically occurs manually after detection and evaluation on an ad hoc basis. There is presently no capability commercially available for rapid adjustment or change of network infrastructure device operation upon the detection of one or more conditions that would trigger such a change. Such a capability would improve network security and efficiency. Therefore, what is needed is a network function arranged to produce a rapid response to a detected condition through a change in the operational features of one or more network infrastructure devices. In particular, what is needed is the capability to provide one command or a limited number of commands to trigger an array of policy and/or policy enforcement adjustment actions. The one or more network infrastructure devices for which a change is effected may or may not be directly associated with the detected condition.

Importantly, the ability to respond in an organized manner to distributed attacks is currently relatively limited. For purposes of this discussion, a distributed attack is one in which a plurality of network system devices are included in the activity. A network system having network intrusion detection “protection” may nevertheless be harmed by a distributed attack. That is, individual network infrastructure devices may not be compromised in their operation, but a plurality of network system devices may be used in combination to compromise a specific network system device. An example of a distributed attack is the SQL Slammer. By the time the network administrator recognizes the nature of the distributed attack, it may be too late to implement policy changes on the individual network system devices associated with the distributed attack. Therefore, what is needed is a response system capable of effective and relatively rapid response to distributed attacks. What is also needed is a rapid response system that may be implemented in a limited bandwidth environment, for example, during an attack.

### SUMMARY OF THE INVENTION

The present invention is a rapid response or lockdown system and related method for directly changing the operation of any one or more network system devices in response to a triggering condition, such as a distributed attack. In addition to other aspects, the invention includes a response function enabled in one or more selected network system devices. The response system includes a policy enforcement function (“PEF”), a policy manager function, and either or both of policy set(s) and policy enforcement rule (“PER”) set(s) stored on one or more network system devices. The PEF implements stored or generated PER set(s). Among other functions to be described herein, the policy manager function provisions policy and/or PER sets, and initiates the implementation of policy enforcement changes. For the purpose of this description, a policy “set” may constitute one or more policies and a PER “set” may constitute one or more PERs. Policy sets and PER sets are identified by unique rapid response identifiers.

The network system devices may have unique combinations of policy and/or PER sets, all devices may have the same policy and/or PER sets, or there may be one or more groups of devices having particular policy and/or PER sets stored thereon. A policy set may include one or more lockdown policies and a PER set may include one or more lockdown PERs. A lockdown policy or lockdown PERs provide for restriction of network access or usage based on one or more triggers, wherein the restriction is a reduction in the access or usage otherwise available under what the administrator defines as normal operating conditions, whatever they may be. The policy and/or PER sets may be pre-installed, updated, re-installed, revised, or otherwise changed when and as desired. One or more network system devices include a PEF, and any one or more network system devices may have a plurality of PEFs.

The rapid response identifiers form a shorthand method to refer to any set of pre-installed policy(ies) or PERs in a PEF in a network system device. Latency, efficiency and stable operation over limited network bandwidth channels are important parameters during time of potential, imminent or ongoing attack. Policy sets and/or PER sets comprise any set of policies, PERs or commands for execution in the PEF initiated by the signaling to the PEF of one or more rapid response identifiers. The policy sets and PER sets identified by the rapid response identifiers are, in effect, rapid response policies and/or rapid response PERs designed to provide a rapid response, by modification, neutralization, repulsion, or bandwidth limiting on ingress or egress to any perceived trigger condition. For purposes of this description, a “trigger” is any detected or observed event, activity, occurrence, information or characteristic identified in a network system by the network administrator as being of interest for the purpose of making a modification to an assigned set of policies and/or PERs. For purposes of the description of the present invention, the term “network administrator” includes network management teams, managers, operators, and monitored and monitoring devices. The types of triggers that define usage restrictions may be of any type of interest to the network administrator. Triggers may be preloaded, developed, generated sporadically or regularly. They may simply be hunches or intuitions had by one or more individual operators observing the network system. It can be readily understood by those skilled in the art that rapid response may take many forms, ranging from complete network stoppage to blocking of a specific MAC address or IP service port, for example. Through prior storage of rapid response policy and/or PER sets, the rapid response system of the present invention is intended to provide an immediate response to the perceived trigger condition in order to protect the network, including, for example, complete stoppage while a more tailored response to the trigger condition may be developed. Rapid response may be a complete and immediate lockdown of the network, or it may be graduated and iteratively implemented within and across multiple PEFs. Relatedly, release from such a lockdown may be complete and immediate, or it may be graduated and iteratively implemented within and across multiple PEFs.

The PEF may be enabled in one or more network system devices, including, for example, a Wide Area Network (WAN) router, a central switch device, a network entry device, a network management device, or any combination of network system devices. A PEP referred to in RFC 3198 would include such policy enforcement functionality. The PEF implements the PERs associated with a policy. The PEF may implement PERs already stored on the device; it may map PERs from policy set(s) already stored, or a combination of the two. For example, in one network system device, a rapid response command may be received to implement a designated policy set, while in another device, a command may be received to implement a designated PER set. The former device would include some mapping function to map the instructed policy set into PERs that the device is capable of carrying out. On the other hand, the latter device would be positioned to implement the designated PERs without the mapping step and therefore would likely implement them in a quicker fashion. As with the other functions of the system of the present invention, the PEF may be established in hardware, firmware, software, or any combination thereof.

The primary roles of the policy manager function are to provision policy and/or PER set(s) to network system devices including the PEF, and to initiate policy and/or enforcement rule changes on those devices. The PDP referred to in RFC 3198 could be one type of such a policy manager function. The policy manager function also includes an analysis function designed to receive and/or assess network information for triggers requiring policy changes. The analysis function further determines whether to provision new policy and/or PER sets to one or more PEFs, and whether to activate which one or more policy and/or PER sets for which one or more specified PEFs. A human being may provide the policy manager function, manually provisioning devices with policies, analyzing events using intuition or experience rather than a pre-configured database of triggers, and deciding to activate policy changes based on his own intuition and problem-solving skills. The policy manager function acts to rapidly initiate designated changes based on detected triggers resulting from the monitoring of the network system, the gathering of relevant data, or other types of information inputs. It is to be noted that a PEF and a policy manager function may co-exist on the same network system device. Also, the policy manager function may exist on one or more other devices and, further, the policy manager function may serve up policy implementation instructions to one or more network system devices, including or excluding a device on which it co-exists with a PEF. Further, the policy manager function may be distributed or hierarchical, with, for example, one policy manager function controlling the generation of installed policy implementation instructions for a plurality of other policy manager functions to in turn be passed along to the relevant PEF(s).

The policy manager function, whether an automated process or a human being, receives information regarding status and traffic of the network system, possibly including intrusion detection messages, and compares that information with normal network behavior and known triggers information. For example, the policy manager function observes the network for information determined to be harmful or potentially harmful. Upon detection of a trigger condition met or observed or reported anomalies, the policy manager function may or may not generate policy enforcement instructions for implementation by one or more selected PEFs. The policy manager function may include one or more updateable databases of trigger information and policy and/or PER sets deemed responsive to such triggers. The one or more databases may include inherent knowledge held by a network administrator. The policy manager function may further monitor and gather relevant event data, store events, histories, logs, products, product mappings, data dictionaries and other information deemed by the administrator to be of value. The policy manager function may include a mapping function for mapping policies to PERs. The policy manager function may coordinate communications among enforcement devices, such as by broadcast, multicast, and unicast messages. It may further manage the state of the PERs for one or more PEFs. The policy manager function may also confirm the status of implementation of an initiated policy/rule set change. As with the other functions of the system of the present invention, the policy manager function and any related functions may be established in hardware, firmware, software, human experience, or any combination thereof.

As noted, the policy manager function of the invention initiates execution of designated policy and/or PER sets that have been provisioned to one or more PEFs. The policy manager function initiates implementation of one or more policy and/or PER sets by instructing one or more PEFs, directly or through one or more other policy manager functions, to implement the designated policy and/or PER sets. The policy manager function communicates to the applicable PEF(s) through one or more shorthand rapid response identifiers the policy and/or PER set(s) to be implemented for the purpose of rapid response to trigger information.

The system of the present invention includes one or more network system devices with PEF directly or indirectly connected to the policy manager function. That is, such devices are configured with a PEF to implement policy set(s) or PER set(s) based on the rapid response identifier(s) communicated by the policy manager function. These devices include one or more physical or logical connection points or ports through which policies are enforced. Upon receiving information about one or more triggers deemed to require a response, the policy manager function selects the relevant policy and/or PER set(s) deemed responsive to the trigger(s), selects the particular PEF(s) to be used to implement the selected policy and/or PER set(s) previously installed on those PEFs, and communicates the rapid response identifier(s) for those selected policy and/or PER set(s) to be implemented. It is to be understood that the triggers, triggers-to-policies mappings, policy sets, PER sets, and rapid response identifiers may be updated or adjusted by the policy manager function at any time.

In one aspect of the invention, a method is provided for responding to one or more triggers involving a plurality of network infrastructure devices of a network system, the method comprising the steps of installing on one or more of the plurality of network system devices prior to detection of the one or more triggers one or more policy sets, one or more PER sets, or a combination of both associated with usage of the network system, monitoring the network system for the one or more triggers, identifying each of the policy set(s) and PER set(s) with a unique rapid response identifier, upon detection of one or more triggers deemed to require a response, selecting one or more of the policy sets, PER sets, or a combination of the two deemed responsive to the one or more triggers, and signaling the one or more of the plurality of network system devices to implement a select one or more of the one or more installed policy sets and/or PER sets through one or more of the rapid response identifiers. The policy and/or PER sets may include one or more sets of graduated network system usage restrictions. The step of signaling may include the steps of initiating the implementation of a first set of network usage restrictions and then initiating a second set of network usage restrictions more restrictive than the first set or, alternatively, less restrictive than the first set. The second set of restrictions may be initiated upon detection of a second set of one or more triggers, a timeout, or a manual initiation. The first set of restrictions may be initiated on the same bases. The step of signaling may also include the steps of signaling a first set of the one or more of the plurality of network system devices to implement a first one of the one or more installed policy sets and/or PER sets and signaling a second set of the one or more of the plurality of network system devices to implement a second one of the one or more installed policy sets and/or PER sets. In that case, the first one of the one or more installed policy sets and/or PER sets may be more restrictive than the second one of the one or more installed policy sets and/or PER sets. Further, the step of signaling may include the step of signaling a first set of the one or more of the plurality of network system devices to implement an installed policy or PER set without changing an implemented installed policy or PER set of a second set of the one or more of the plurality of network system devices.

In another aspect of the invention, a system is provided for responding to one or more triggers involving a plurality of network system devices of a network system, the system comprising one or more of the plurality of network system devices having pre-installed thereon one or more policy sets, one or more PER sets, or a combination of the two associated with usage of the network system, a PEF, and a policy manager function for monitoring the network system for triggers and instructing the one or more of the plurality of network system devices to implement a select one or more of said one or more pre-installed policy sets and/or PER sets based on unique rapid response identifiers. The policy manager function compares triggers with the conditions of the one or more pre-installed policy and/or PER sets, or observes network behavior anomalies and signals the PEF to implement the one or more of the pre-installed policy and/or PER sets.

In another aspect of the invention, there is an article of manufacture comprising a machine-readable medium that stores executable instruction signals that cause a machine to perform the method described above and related methods described herein.

The details of one or more examples related to the invention are set forth in the accompanying drawings and the description below. Other features, objects, and advantages of the invention will be apparent from the description and drawings, and from any appended claims.

### BRIEF DESCRIPTION OF THE DRAWINGS

FIG. 1 is a simplified diagrammatic block representation of an example network system with the response system of the present invention.

FIG. 2 is a simplified block representation of a network infrastructure device including the policy enforcement function of the present invention.

FIG. 3 is a simplified block representation of a policy manager function of the present invention.

FIG. 4 is a flow diagram of a process of the present invention for responding to triggers.

### DETAILED DESCRIPTION OF PREFERRED EMBODIMENTS OF THE INVENTION

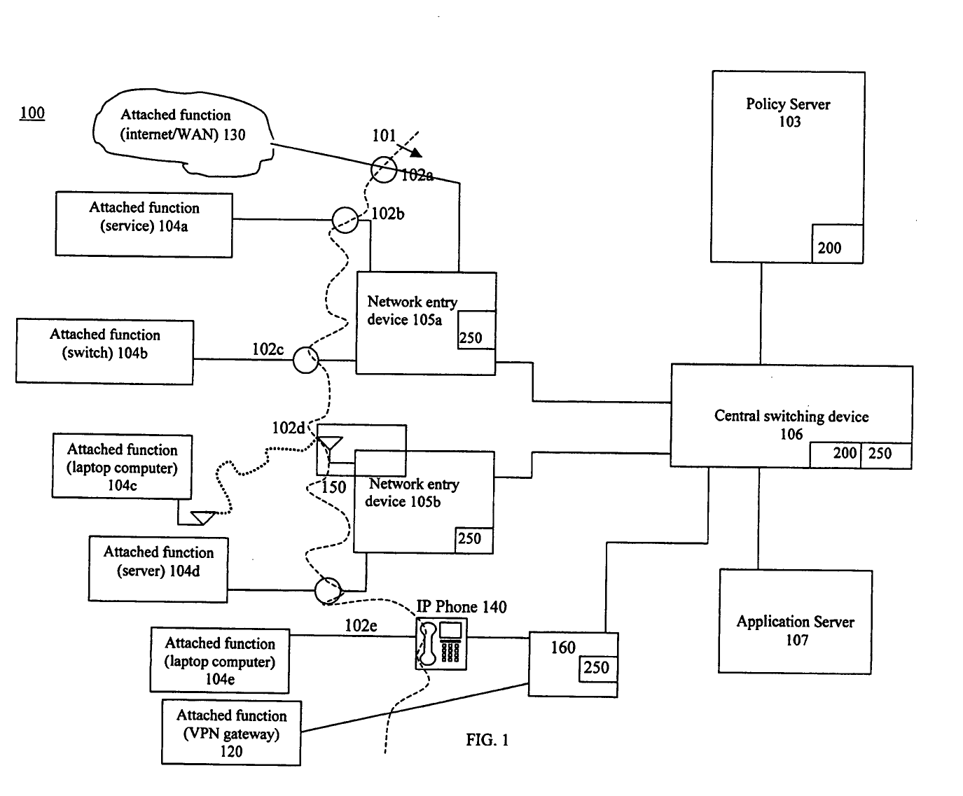

The present invention is a system and related method to respond, in a rapid manner, to triggers associated with the operation of a network system. Referring to FIG. 1, a network system 100 incorporating the capability of the response system of the present invention operates and provides network services to attached functions according to policies and PERs to devices of a network infrastructure 101 through which the attached functions access and use services of the network system 100. Network system 100 includes the network infrastructure 101 and one or more attached functions connected to or connectable to the network infrastructure 101. The network infrastructure 101 includes multiple switching devices, routing devices, firewalls, IDSs, access points, Metropolitan Area Networks (MANs), WANs, Virtual Private Networks (VPNs), and internet connectivity interconnected to one another and connectable to the attached functions by way of connection points (e.g., 102a-e). The network infrastructure 101 includes such devices having forwarding functionality for the purpose of accessing and using network services.

A response system of the present invention includes a PEF 250 and a policy manager function 200. The policy manager function 200 preferably includes, at a minimum, an analysis function and an implementation function. The analysis function analyzes monitored information to determine whether that information includes one or more conditions, events, occurrences, etc. (“triggers”) for the purpose of implementing one or more policy enforcement changes. The analysis function further determines whether the one or more triggers require the implementation of one or more responses through the PEF 250. The implementation function of the policy manager function 200 signals to specific PEFs particular enforcement policy and/or PER sets to be implemented thereon in response to the trigger(s). The policy manager function 200 associates responsive policies to be implemented and signals the selected PEF(s) with one or more rapid response identifiers corresponding to the selected policy sets and/or PER sets. The rapid response identifiers are shorthand designations each uniquely associated with a particular policy set and/or PER set. Policies, through the PERs, may be implemented differently on different PEFs and may be implemented and removed at different times and gradually or completely. For example, the signaling of the implementation of a particular rapid response policy may cause one type of operation by one PEF and another type of operation by another PEF. For purposes of this description, a device with at least one PEF may include a network device as traditionally understood. It may also be a port or set of ports or an interface, such as a virtual interface, or a set of such interfaces.

Continuing with reference to FIG. 1, an attached function is external to infrastructure 101 and forms part of network system 100. Examples of attached functions 104a-104e are represented in FIG. 1, and may be any of the types of attached functions previously identified. Network infrastructure entry devices 105a-b, 140, and 160 of infrastructure 101 provide the means by which the attached functions connect or attach to the infrastructure 101. Alternative entry means may be used as noted in the following paragraph. A network entry device can include and/or be associated with a wireless access point 150. For wireless connection of an attached function to the infrastructure 101, the wireless access point 150 can be an individual device external or internal to the network entry device 105b. For the purpose of illustrating the response system of the present invention, each of the network entry devices except phone 140 includes the PEF 250. It is to be noted that a phone may include a PEF; however, that is not shown in FIG. 1. The network system 100 may include other network devices without the PEF 250. One or more centralized network infrastructure devices may include the PEF 250. Further, there may be a combination of network entry and centralized forwarding devices having the PEF 250 of the present invention. It is also to be noted that a PEF 250 may be included as part of one or more attached functions.

One or more central forwarding devices, represented by central switching device 106, enable the interconnection of a plurality of network entry devices, such as devices 105a-b and 160, as well as access to network services, such as policy server 103 or an application server 107. It is to be understood that a central forwarding device, or an entry forwarding device, is not limited only to switches as that term is traditionally understood. Instead, the forwarding device may be any device capable of forwarding signals through the network infrastructure pursuant to forwarding protocols. The central switching device 106 enables the interconnection of the network infrastructure 101 to attached functions that include VPNs (represented by VPN gateway device 120) and WANs (represented by internet cloud 130) as well as Internet Protocol (IP) telephones (represented by telephone 140). It is to be understood that the IP telephone 140 may also perform as a network entry device for the purpose of connecting an attached function, such as a laptop computer, to the network infrastructure 101.

One or more devices of the network infrastructure include the PEF 250 of the response system of the present invention. The PEF 250 includes one or more policy and/or PER sets each associated with a unique rapid response identifier, pre-installed on the one or more network system devices including, for example, entry devices 105a, 105b, and 160, as well as central switching device 106. The PEF 250 may be established in hardware and/or software (e.g., a function embodied in an application executing on one or more devices of the network infrastructure 101) to implement responses. The particular network device on which the PEF 250 resides may vary from manufacturer to manufacturer. As previously indicated, a device may also be a port or set of ports, an interface or a set of interfaces.

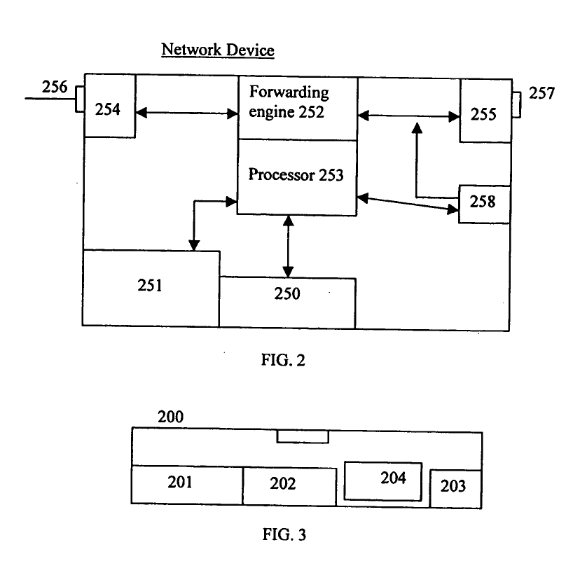

As illustrated in FIGS. 2 and 3, the response system of the present invention includes several functions and elements. It is to be noted that all functions and elements may be embodied in one or more devices of the network 100. However, the PEF 250 of FIG. 2 will preferably be embodied in one or more forwarding devices of the network infrastructure 101, and the policy manager function 200 of FIG. 3 may be embodied in one or more centralized devices of the network infrastructure 101 including, for example, the policy server 103. However, it is to be noted that there may be a plurality of policy manager devices, each configured to distribute one or more different policy and/or PER sets. For example, there may be a policy manager function configured for packet forwarding, one for database access, another for application access, yet another for authentication and/or authorization, another for accounting, another for reporting, another to define when a human operator or administrator is or is not to be contacted regarding a detected event, and so on. Such different types of policy manager functions may be embodied in one or more devices.

A network device including the PEF 250 preferably also includes storage means 251, such as a database or a caching function, having one or more installed policy and/or PER sets, and corresponding related rapid response identifier(s), any of which may be updated or changed as desired. Whether a particular network device with PEF 250 specifically includes the policy and/or PER sets stored directly thereon is dependent upon the particular hardware and programming of the device. A “simple” device will likely only have a store of PER sets to be implemented. That is, the policy manager function 200 will simply communicate to the PEF 250 through the network device using the rapid response identifier(s) the one or more PER sets to be implemented. On the other hand, a “sophisticated” device may only have stored policy set(s) to be implemented. For that device, the policy manager function 200 will simply communicate to the PEF 250 through the network device using the rapid response identifier(s) the one or more policy sets to be implemented. It is then up to the sophisticated device to map the communicated policy set represented by the rapid response identifier(s) into PER set(s) suitable for the sophisticated device to implement, perhaps slightly differently based on port type, speed or usage. A mapping function is required as part of the sophisticated device for that purpose and may provide more specific tailoring of the policies to the exact device and/or port or interface. The storage means 251 may be updated periodically or as a result of an event occurring anywhere in the network infrastructure 101. The storage means 251 may be a single database comprised of one or more updateable tables of information. A network infrastructure device having forwarding functionality and with the PEF 250 includes a forwarding engine 252, a processor 253, an ingress port interface 254, an egress port interface 255, and a communication function 258.

As shown in FIG. 3, the policy manager function 200 includes an analysis function 201, an implementation function 204, and a database 202. The policy manager function 200 further includes a communication function 203 including means for receiving network information, such as from an IDS designed to detect intrusion information occurring at one or more network infrastructure connection points. Further, the policy manager function 200 may receive through the communication function 203 trigger information from other means, such as a human operator or administrator to initiate the analysis and/or PEF 250 operation. The communication function 203 also includes means for the policy manager function 200 to exchange messages with one or more network system devices, including those devices with PEF 250. The communication function 203 may be one or more connections to one or more network system devices having the capability to implement policy change instructions, to detect intrusions and report detected intrusions to other devices of the network infrastructure 101, or a combination of both.

The database 202 of the manager function 200 includes trigger information. The trigger information may be any type deemed by the network administrator suitable for generating a policy change at one or more network system devices. Examples of triggers and possible policy changes are provided in co-pending U.S. patent application Ser. No. 10/629,331 entitled “System and Method for Dynamic Network Policy Management” of John Roese et al. and assigned to a common assignee. The entire content of that co-pending application is incorporated herein by reference. The trigger information may be generated by the policy server 103, some other sort of centralized network infrastructure device, or from a peer, and stored in the database 202. The trigger information is stored or cached in the database 202 in advance and is not solely supplied in reaction to a triggering condition or event that may be occurring on that particular network system device. Examples of policies stored in database 251 are provided in co-pending U.S. patent application Ser. No. 10/629,331 entitled “System and Method for Dynamic Network Policy Management” of John Roese et al. and assigned to a common assignee. The database 202 may further include, for example, means for finding PEFs 250, rapid response identifiers to policy and/or PER set mappings, historical information, event logs, policy set to policy implementation element mapping, policy element to policy enforcement function element mapping, and the like. The information of storage means 251 may also be stored in database 202 of policy manager function 200. Database 202 containing the policy and/or PER set information available for all network system devices including the PEF 250.

With continuing reference to FIGS. 2 and 3, the analysis function 201 performs the function of evaluating network information, determining whether the information includes one or more triggers requiring initiation of one or more changes of one or more policy and/or PER sets, and matching detected triggers with appropriately responsive policies. The analysis function 201 may provide choices on options for responding to particular triggers, the gathering of additional information from the same and/or additional sources, initiating a response delay to prevent thrashing, reporting to other policy manager functions, creating new and/or modified policy and PER sets, and enabling policy changes including complete or tailored network lockdown. Upon recognition of trigger information stored in the database 202, the analysis function 201 selects the rapid response identifier(s) deemed responsive to that trigger information received. The rapid response identifier, unique to each particular policy set, PER set, or combination of policy and PER set(s), may be any form of an alphanumeric representation included in a table associating triggers with responsive policies and/or PERs. The analysis function 201 passes the rapid response identifier(s) to the implementation function 204, which in turn instructs the PEF 250 by way of the rapid response identifier(s) to implement the policy and/or PER set by signaling the processor 253 to initiate the enforcement of the selected policy and/or PER set(s). That signaling may be achieved as through communication using multicast and/or broadcast communication methods, but not limited thereto. In particular, such means of communication may enable the rapid implementation of policy and/or PER set(s). It is to be noted that the policy manager function 200 may include a mapping function to translate policies into PERs.

The rapid response identifier (or identifiers) may be distributed by unicast, multicast, or broadcast distribution including, for example a Layer 2 or Layer 3 multicast protocol distribution. In general, in a forwarding situation, the processor 253 provisions the forwarding engine 252 with new forwarding rules based on the identified policy and/or PER set(s) that the device has been instructed to implement. This arrangement establishes within the network system device having the PEF 250 the ability to automatically implement policy changes with only the exchange of the identifier of the policy(ies) and/or PERs to be enforced. The policy and/or PER set identified may be changed based on further evaluation of the network. For example, a first trigger may cause the policy manager 200 to initiate the enforcement of a policy designed to lockdown the network upon detection of a virus on the network system 100. That particular policy may be a complete denial of access to a port or ports of one or more network system devices including the PEF 250. Upon further evaluation of the characteristics or after a specified period of time, for example, it may be determined that that particularly restrictive policy in place is to be replaced with a less restrictive policy, including, optionally, a complete or partial return to the operating policy(ies) until or at such time as the virus is deemed eliminated.

Referring back to FIGS. 1 and 2, an attached function such as a service 104a attaches to infrastructure 101 through connection point 102b (e.g., a jack in a wall). Network infrastructure entry devices 105a-b and central switching device 106 connect to each other using cables and connection points in a similar manner. A connection port is the physical port through which a network client communicates. Referring to FIG. 2, the network entry device includes ingress port 256 and an egress port 257. The network entry device is configured at ingress port interface 254 to recognize and exchange signals with the attached function. The signals pass from the ingress port interface 254 to the forwarding engine 252 for forwarding decisions. Forwarding decisions include, but are not limited to, forwarding through egress port interface 255 received signals to other network infrastructure devices, such as an authentication server, the application server 107, and the central switching device 106. The forwarding engine 252 may be any type of forwarding function including, but not limited to, a Layer 2 switch or bridge or a Layer 3 router. The processor 253 communicates with the forwarding engine 252, the database 251, and, via the egress port interface 255, the policy manager function 200. One or more of the described interfaces, functions, forwarding engine, and processor may be discrete components, or parts of one or more common components. They may be coupled together as module components in any combination of hardware, firmware, software, microcode or any combination thereof.

Access by an attached function to the network services associated with network system 100 includes a setting of static and/or dynamic policies, referred to generally as a set of policies, for the attached function. Sets of policies are initially established by the network administrator or by pre-installed ingress and egress policies. Information regarding an attached function seeking or having access to network services and the policies may be stored centrally or in a distributed manner, including being stored locally. In an example of a centralized approach, attached function and policy information for all of the connection points of the network system 100 is stored in a server such as policy server 103. In an example of a distributed approach, attached function and policy information for all attached functions, or a portion of the attached functions, may be stored in one or more of the local network devices 105a-b and 106 of the network infrastructure 101. The policy server 103 representing a single policy server including all types of policies to be enforced, or representing a distributed policy server set, may include trigger information and provisioning information for one or more network infrastructure devices. It is also to be noted that the policy server 103 as described may be further divided into one or more servers for distributing policy sets to the enforcement functions and one or more servers for distributing just the rapid response identifiers of those policy sets when initiation of enforcement of a policy is desired.

Entry to the network system 100, and the infrastructure 101 primarily, may be initially regulated using authentication systems such as Network Operating Systems (NOSs), Remote Authentication Dial-In User Service (RADIUS), described in IETF RFC 2138, and IEEE 802.1X standard, which provides for port-based network entry control based on a MAC identifier. In the case of NOS and RADIUS, an authentication server provides the mechanism for establishing such authentication. RADIUS may also provide authorization and, optionally, accounting capability related to network usage. In the case of IEEE 802.1X, the network entry devices may be configured with such authentication capability, as described more fully in that standard. IEEE 802.1Q standard provides another means for controlling usage of a network. That standard is directed to the establishment and operation of VLANs. The IEEE 802.1Q standard defines the configuration of network devices to permit packet reception at a configured port entry module. Firewalls also provide a technique for network entry regulation based on their packet analysis functionality previously described.

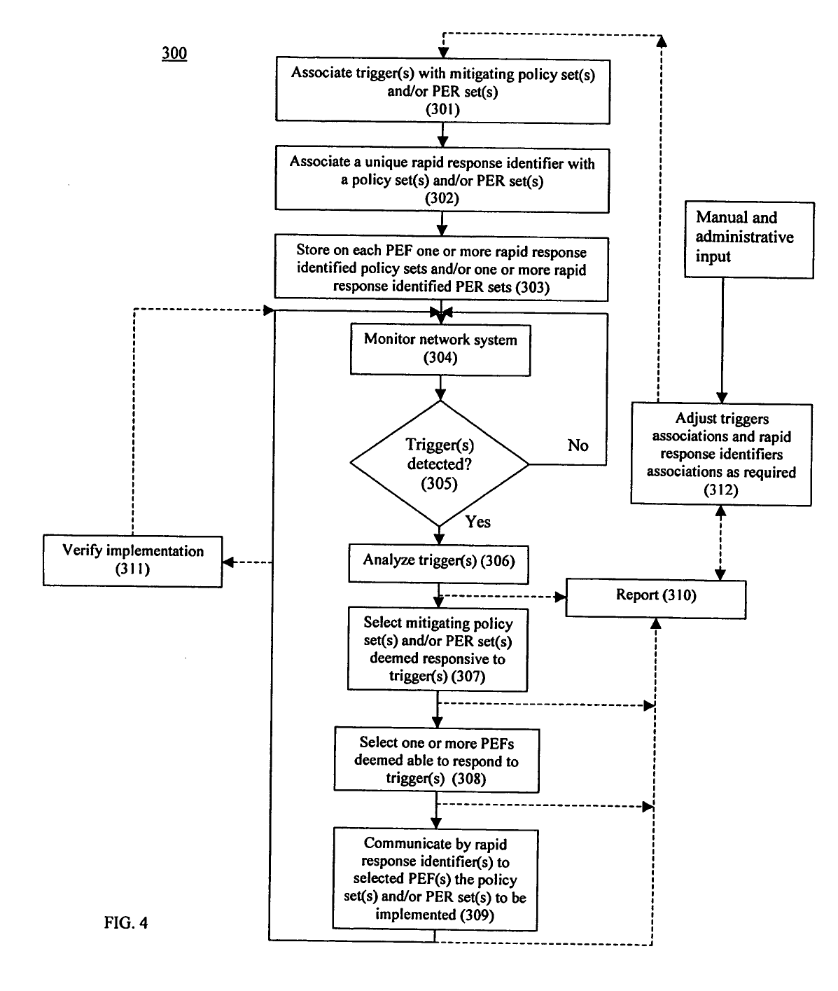

With reference to FIG. 4, in operation, a rapid response process 300 of the present invention preferably occurs at one or more network system devices, including devices with at least the PEF 250 and, optionally, the policy manager function 200. Functioning of the network, entry to it, and preliminary usage rules may be established in a manner consistent with current practice. Process 300 includes the step of associating mitigating policy and/or PER sets with triggers deemed to require such mitigating policy and/or PER sets (step 301). Process 300 also includes the step of associating unique rapid response identifier(s) (302) with policy set(s), PER set(s), or combinations of policy set(s) and PER set(s). Process 300 further includes the step of storing in the storage means 251 of the network system device(s) including the PEF 250, one or more policy sets and/or one or more PER sets having corresponding rapid response identifiers (step 303). The policy and/or PER sets may be provisioned by the network administrator through the policy server 103. The system monitors the network for any information that may constitute a trigger (step 304). It compares that information with triggers stored in the database 202 (step 305) through the analysis function 201. That monitoring may be sporadic or periodic but is preferably continuous, and may be performed by one or more network system devices.

If there is no match between information that may constitute a trigger and the database of triggers requiring responsive action, the monitoring process continues without change to a policy. It is to be noted that this process is applicable for any network system device having one or more ports, including wireless access points and any other sort of virtual interfaces. Further under step 305, if a trigger or triggers match is made, the analysis function 201 initiates the process of analyzing the detected trigger(s) for the purpose of determining which policy and/or PER set(s) may be responsive thereto for the purpose of mitigating any effects that may be associated with the trigger under analysis (step 306). Based on that analysis, one or more rapid response identified policy and/or PER sets are selected for implementation (step 307). In addition, one or more PEFs 250 deemed suitable to implement the selected policy and/or PER set(s) are selected (step 308), either before, while, or after, the mitigating policy and/or PER set(s) is/are selected. The policy manager function 200 communicates with the one or more selected PEFs 250 the selected rapid response identifier(s) to implement (step 309), preferably by instructing the processor 253 to initiate the process of configuring the forwarding engine 252 with the one or more policies and/or PERs identified by the selected rapid response identifier(s).

The monitoring process is continued, or preferably, has remained in effect throughout the trigger identification and rapid response process. An additional optional step of the process 300 includes reporting trigger information, policy and/or PER set selection, PEF 250 implementation selection, and/or rapid response identifiers communications to a repository, such as policy server 103 but not limited thereto, that may be accessed as desired (step 310). Further, the effect of the policy change implementation may be verified or evaluated by, for example, polling the one or more selected PEFs 250 to confirm receipt of the selected rapid response identifiers communicated as well as any or all implementation activities (step 311). Such verification may be of particular interest in those instances when policy change implementation instructions are communicated by multicast or broadcast messaging. It is to be understood that all communications among functions should preferably be secured with acceptable means to insure secure and robust communications among trusted parties. These secure communication techniques, such as encryption, are well known to those skilled in the art. Another optional step of the process 300 is to adjust trigger information, information regarding trigger associations with policy and/or PER sets, and/or rapid response identifier associations based on reported information (step 312), and to report such adjustments to the repository. It is to be noted that such adjustments may be made automatically, manually, or by administrative means.

As indicated, the monitoring is preferably a continuous observation of network traffic. A number of mechanisms exist for automatically monitoring network links, Layer 2 topologies, Layer 3 topologies and the status and utilization of ports and attached functions. For example, Remote Monitoring (RMON) tools and Simple Network Management (SNMP) Management Information Bases (MIBs) are useful and valuable methods to collect the information about network system devices, attached functions, links, network state and status, to provide input into identifying triggers. Input ports on access switches and routers are capable of classifying traffic based on all layers of the ISO (International Standards Organization) seven layer Architecture model. All data fields in the packet may be used along with static and rate based input for input into the trigger monitor.

The following is a list of a few possible devices (but not limited to only those devices) that can contain the policy manager function, the PEF and/or any one or more of the corresponding functions described herein: network switches, data switches, routers, WAN devices, MAN devices, optical switches, firewalls, gateways, computing devices such as network file servers or dedicated usage servers, management stations, Private Exchange Branch (PBX) devices, telecommunication devices, cellular phones, network connected voice over IP/voice over data systems such as hybrid PBXs and VoIP call managers, network layer address configuration/system configuration servers such as enhanced DHCP servers, enhanced Bootstrap Protocol (bootp) servers, IPv6 address auto-discovery enabled routers, and network based authentication servers providing services such as RADIUS, Extensible Authentication Protocol/IEEE 802.1X or others. It is to be noted that the present invention is applicable to telephone as well data communication network systems.

One means to provide the triggers and/or policy and/or PER set information to the databases 202 and 251 is the Simple Network Management Protocol (SNMP). A network administrator provisions the policy information of the terminus of a network cable associated with the attached function. The forwarding engine 252 or other enforcement function reads the terminus information via the SNMP. In another example, MIB parameters may be established or used to obtain and configure the databases 202 and 251 with the triggers and the policy/PER sets. MIBs may also be employed to populate one or more tables of the network system device operating as enforcement devices with historical information for storage and/or caching.

The response system of the present invention, including the pre-installation of policy and/or PER sets, permits rapid enablement of policy changes at the network system devices including the PEF 250, including the ports of those devices. Automatic enablement of policy changes by the PEFs 250 based on receiving trigger information that can be compared with stored trigger information, and then initiating a signaling that results in direct enforcement of one or more policies on one or more PEFs using the rapid response identifiers as shorthand, reduces the turn around time that previously required an exchange of information and instructions among a plurality of network system devices after detection of an event that may or may not be considered an event sufficient to trigger any policy change. Particular examples of instances in which the response system may be employed follow.

In a first example, a virus is detected at an ingress port of a network edge device. The virus detection information is stored in the database 202. The analysis function 201 matches the detected trigger information with one or more policies and/or PERs deemed suitable to respond to the detected trigger information. It then initiates enforcement of the matched and identified policy(ies) and/or rule(s) responsive to the detected trigger by signaling the processor 253 with one or more rapid response identifiers of one or more policy and/or PER sets to be implemented. For example, the policy change may be a complete blocking of the virus on all access ports in the entire network system.

In a second example, the policy manager function 200 of the network system device may detect a duplicate Internet Protocol address coming through via different ingress ports. Upon receipt of the selected rapid response identifier(s) determined to correspond to pre-installed mitigating policy and/or PER set(s), the PEF 250 may block or isolate the address on all ports in the network system. It can be seen that the present invention enables the application of varied policies quickly to all ports of the network system.

In a third example, a plurality of network edge devices having the PEF 250 each receives an excessive amount of a particular type of signal traffic, possibly part of a Denial of Service attack. The analysis function 201 initiates a policy change for each identified network device based on the recognized trigger for each port on which the excess traffic is detected. That changed policy may be a rate limiter designed to limit traffic on the one or more ports identified. The attack would be thwarted but the PEF 250 would permit continued usage of network services at a reduced level without a complete blocking. Another policy to be configured on the identified port or ports would be to set an application priority parameter within the signal traffic received in order to reduce the priority of such traffic relative to traffic that has not been identified through a trigger detection. In that way, non-triggering protocols would continue to be forwarded at their set rates, while the triggering protocol could be forwarded at a reduced rate.

Further examples of response levels corresponding to applicable policy and/or PER sets identified by rapid response identifiers and the related actions and effects they are to produce, are shown in the following table. Individual rapid response identifiers have “RR” designations plus additional designations for each unique response. It is to be understood that this table lists examples only and is not intended to be exhaustive. Those skilled in the art will recognize that many other types of identifiers, actions, and desired effects may be implemented through the present invention using the pre-installed policy and/or PER sets with corresponding rapid response identifiers. The exact PERs or PER sets to enforce the desired effect across a diverse network are often extensive and may require detailed knowledge of the hardware, firmware, and management support including MIBs, APIs and other product features. In addition, detailed knowledge of the network topology, redundancy and protocols is needed to craft the PERs and PER sets to implement the desired effect. All rapid responses could be initiated manually by an authorized administrator either through physical or logical buttons or icons.

| Rapid Response | | | |
|---|---|---|---|
| Identifier | Action | Network Effect | Comments |
| RR 0 | Disable all traffic and | Disables the entire | May require manual |
| | manageability | network | intervention to |
| | | | recover |
| RR 1 | Disables all traffic | Disables all user | |
| | except management | traffic. Routing, | |
| | and control | switching, topology | |
| | | and management | |
| | | operations continue | |
| RR 2 | RR1 traffic allowed | | Assumes VoIP not |
| | plus emergency | | under attack |
| | services like 911 | | |
| | phone service | | |
| RR 3 | RR 2 traffic allowed | Allows user level | |
| | plus all VoIP traffic | phone service | |
| RR 4 | RR 3 traffic allowed | Business Continuity | |
| | plus selected trusted | level. Bandwidth | |
| | Business applications | limitation and QoS to | |
| | | guarantee accessibility | |
| | | to network devices for | |
| | | control and | |
| | | management purposes | |
| RR 5 | RR 4 traffic plus all | QoS for network | |
| | business applications | manageability | |
| RR 6 | Business applications | No inbound Internet | |
| | plus internet access | services | |
| RR 7 | RR 6 traffic plus | | |
| | internet inbound VPN | | |
| | services | | |
| RR 8 | Acceptable usage | Network returned to | |
| | policies prevail | “normal“ operation | |
| RR - N | Many other levels | Implements customer | May use a single |
| | allows | specific modes across | broadcast command, |
| | | the network rapidly | Follow-up for |
| | | | confirmation, with |
| | | | individual |
| | | | acknowledgements |
| RR Diagnostics | Special rapid | Reboot the network | May be time delayed |
| | response to force | | |
| | devices to perform | | |
| | diagnostics and/or | | |
| | reboot to purge | | |
| | infected devices | | |
| RRLoad | Special rapid response | New image, perhaps a | Could save the old |
| | level to load a new | reboot, topology may | topology tables |
| | code image, perhaps | or may not be | (speed) or rebuild. |
| | with a vital bug fix or | affected. | |
| | special filters | | |
| RR (MAC address) | Disables this address | No access for this | |
| | everywhere on the | device | |
| | network | | |
| RR (IP address) | Disables this address | No access for this | Limited value in |
| | everywhere on the | device | DHCP environments |
| | network | | |
| RR S 1 | Special level for a | Minor effects to other | May be triggered |
| | specific known attack | protocol perhaps but | automatically by |
| | like Blaster or the | tailored to a specific | detectors (IDS) |
| | SQL slammer | attack | |
| RRS (Blaster) | Special level to | Minor effects to other | May be triggered |
| | specifically disable | protocols may make | automatically by |
| | Blaster | this state something to | detectors (such as an |
| | | only implement as | IDS) |
| | | absolutely required | |
| RRS (SQL slammer) | Special level to | Any major side effects | May be triggered |
| | specifically disable | to other business | automatically by |
| | the SQL slammer | activity may limit | detectors (IDS) |
| | | these filters to only be | |
| | | enabled during attack. | |
| RR Return | PEF returns to | | Useful to rapidly get |
| | previous or normal | | device back to where |
| | policy state | | they were |
| RR default | PEF returns to default | | Achieves policy |
| | policy state | | default state no matter |
| | | | how messed up an |
| | | | administrator made it. |

As previously indicated, it is to be understood that the functions described herein may be implemented in hardware and/or software. For example, particular software, firmware, or microcode functions executing on the network infrastructure devices can provide the implementation function. Alternatively, or in addition, hardware modules, such as programmable arrays, can be used in the devices to provide some or all of those capabilities.

Other variations of the above examples may be implemented. One example variation is that the illustrated processes may include additional steps. Further, the order of the steps illustrated as part of the process is not limited to the order illustrated in FIG. 4, as the steps may be performed in other orders, and one or more steps may be performed in series or in parallel to one or more other steps, or parts thereof. For example, the triggers and/or policy and/or PER sets may be updated periodically or sporadically. Further, the analysis of trigger information and the implementation of a policy change may be performed directly by the PEF 250 without a policy manager function interface. Moreover, the analysis function 201 may be implemented as a policy decision and a separate policy implementation or as a distributed process. That is, the determination of the particular policy or rule to be used based on particular trigger information may reside in one or more portions of the network system while the function of directing the PEF(s) to implement such selected one or more policy and/or PER sets may reside in one or more other portions of the network system. It is further to be noted that a common rapid response identifier of a policy and/or PER set or sets to be implemented may result in different implementations for different PEFs receiving the rapid response identifier, further the PERs may be different for each port supported by a PEF or PEFs, and/or may be implemented on a per port or per interface basis.

Additionally, the processes, steps thereof and various examples and variations of these processes and steps, individually or in combination, may be implemented as a computer program product tangibly as computer-readable signals on a computer-readable medium, for example, a non-volatile recording medium, an integrated circuit memory element, or a combination thereof. Such computer program product may include computer-readable signals tangibly embodied on the computer-readable medium, where such signals define instructions, for example, as part of one or more programs that, as a result of being executed by a computer, instruct the computer to perform one or more processes or acts described herein, and/or various examples, variations and combinations thereof. Such instructions may be written in any of a plurality of programming languages, for example, Java, Visual Basic, C, or C++, Fortran, Pascal, Eiffel, Basic, COBOL, and the like, or any of a variety of combinations thereof. The computer-readable medium on which such instructions are stored may reside on one or more of the components of system 100 described above and may be distributed across one or more such components.

A number of examples to help illustrate the invention have been described. Nevertheless, it will be understood that various modifications may be made without departing from the spirit and scope of the invention. Accordingly, other embodiments are within the scope of the claims appended hereto.

What is claimed is:

1. A method for responding to one or more triggers involving a plurality of network devices of a network system, the method comprising the steps of:
a. installing on one or more of the plurality of network devices, prior to detection of the one or more triggers, one or more policy sets, one or more policy enforcement rule (PER) sets, or a combination of policy and PER sets, associated with usage of the network system;
b. designating each of the policy sets and PER sets with a unique rapid response identifier;
c. monitoring the network system for the one or more triggers;
d. upon detection of one or more triggers deemed to require a response, selecting one or more policy sets and/or PER sets deemed responsive to the one or more triggers; and
e. instructing one or more of the one or more network devices to implement the selected one or more policy sets and/or PER sets by communicating thereto one or more of the rapid response identifiers associated with the selected one or more policy sets and/or PER sets.

2. The method as claimed in claim 1 wherein the one or more network policy sets and/or PER sets selected for implementation permit only minimal network functionality through the one or more of the plurality of network devices.

3. The method as claimed in claim 2 further comprising the step of examining one or more portions of the network for effects of the one or more triggers considered to be likely to destabilize the network.

4. The method as claimed in claim 3 further comprising the steps of identifying the one or more portions of the network not affected by the one or more triggers and releasing from minimal network functionality those network devices identified as not affected by the condition.

5. The method as claimed in claim 3 further comprising the steps of identifying the one or more portions of the network affected by the one or more triggers and implementing one or more policy and/or PER sets specifically responsive to the identified one or more triggers only on those network devices of the identified portions of the network.

6. The method as claimed in claim 5 further comprising the step of replacing one or more of the one or more selected policy and/or PER sets implemented on those network devices of the identified portions of the network with one or more release policy and/or PER sets upon determination that the minimal network functionality restriction is to be released.

7. The method as claimed in claim 6 wherein the release is performed incrementally from more restrictive network usage policy set(s) and/or PER set(s) to less restrictive policy set(s) and/or PER set(s).

8. The method as claimed in claim 7 wherein the incremental release includes the steps of applying less restrictive policy set(s) and/or PER set(s), evaluating network stability, and then releasing all restrictive policy set(s) and/or PER set(s) through the network devices upon determination that the network is stable.

9. The method as claimed in claim 1 further comprising the steps of applying one or more of the identified one or more installed policy sets and/or PER sets incrementally as a function of the detection of the one or more triggers, and adjusting the application of the one or more installed policy sets and/or PER sets by adding, removing or changing the implementation of the one or more installed policy sets and/or PER sets upon further detection of the one or more triggers until network stability is achieved.

10. The method as claimed in claim 9 further comprising the step of incrementally adjusting the application of the one or more installed policy sets and/or PER sets by adding, removing or changing implementation of the one or more installed policy sets and/or PER sets for specific identified ones of the network devices to remove network usage restrictions upon determination of removal of the existence of the detected one or more triggers.

11. The method as claimed in claim 1 wherein one or more of the one or more installed policy sets and/or PER sets are applied to one or more subsets of the network devices as a function of the detected one or more triggers.

12. The method as claimed in claim 11 wherein the one or more installed policy sets and/or PER sets are applied in an incrementally more restrictive manner.

13. The method as claimed in claim 12 further comprising the steps of continuing to monitor the network for additional one or more triggers and adjusting the application of the one or more installed policy sets and/or PER sets as a function of the detection of the one or more triggers until stability of the one or more subsets is achieved.

14. The method as claimed in claim 13 further comprising the step of continuing to monitor the network for additional one or more triggers and adjusting the application of the one or more installed policy sets and/or PER sets as a function of the detection of the one or more triggers until stability of the entire network is achieved.

15. The method as claimed in claim 14 further comprising the step of removing the one or more installed policy sets and/or PER sets by identified one or more subsets of the network devices upon determination that such one or more subsets are not affected by the detected one or more triggers.

16. The method as claimed in claim 1 wherein the trigger for initiation of the rapid response change is from an input from a button, logical button, icon activation or other human initiated action.

17. The method as claimed in claim 16 wherein the input is a single action.

18. A system for responding to one or more triggers involving a plurality of network devices of a network system, the system comprising:
a. one or more of the plurality of network devices having installed thereon one or more policy sets, one or more policy enforcement rule (PER) sets, or a combination of policy sets and PER sets;
b. an analysis function for analyzing monitored information and relating policy change triggers with the monitored information;
c. an implementation function for signaling one or more policy set or PER set changes based on rapid response identifiers corresponding to each of the one or more policy sets and PER sets; and
d. a policy enforcement function (PEF) for implementing on one or more of the one or more of the plurality of network devices a select one or more of the one or more installed policy sets and/or PER sets based on the rapid response identifiers received from said implementation function.

19. The system as claimed in claim 18 wherein said analysis function and said implementation function form part of a policy manager function.

20. The system as claimed in claim 18 wherein said PEF forms part of one or more of the one or more of the plurality of network devices.

21. The system as claimed in claim 18 wherein the monitored information is information received from an intrusion detection function.

22. The system as claimed in claim 18 wherein at least one of the one or more of the plurality of network devices is a network entry device.

23. The system as claimed in claim 18 wherein at least one of the one or more of the plurality of network devices is a central switching device.

24. The system as claimed in claim 19 wherein the policy manager function further includes a database of triggers, policies, and PERs.

25. The system as claimed in claim 18 wherein the trigger for initiation of the rapid response change is from an input from a button, logical button, icon activation or other human initiated action.

26. The system as claimed in claim 25 wherein the input is a single action.

27. A method for responding to one or more triggers involving a plurality of network devices of a network system, the method comprising the steps of:
a. mapping one or more policies to one or more corresponding policy enforcement rules (PER);
b. installing on one or more of the plurality of network devices, prior to detection of the one or more triggers, one or more policy sets, one or more PER sets, or a combination of policy and PER sets, associated with usage of the network system;
c. monitoring the network system for the one or more triggers;
d. upon detection of one or more triggers deemed to require a response, selecting one or more policy sets and/or PER sets deemed responsive to the one or more triggers; and
e. instructing one or more of the one or more network devices to implement the selected one or more policy sets and/or PER sets by broadcast or multicast communication.

28. The method as claimed in claim 27 further comprising the step of designating each of the policy sets and PER sets with a unique rapid response identifier.

29. The method as claimed in claim 27 further comprising the step of polling the one or more of the one or more of the network devices to confirm implementation of the selected one or more policy sets and/or PER sets.

30. The method as claimed in claim 27 wherein the trigger for initiation of the rapid response change is from an input from a button, logical button, icon activation or other human initiated action.

31. The method as claimed in claim 30 wherein the input is a single action.
